(19) United States
(12) Patent Application Publication
(10) Pub. No.: US 2019/0168555 A1
(43) Pub. Date: Jun. 6, 2019

(54) Trailer Dolly associated Variable Terrain Trailer Hitch Stabilizer

(71) Applicant: Peter Wayne Axelson, JR., Aylmer (CA)

(72) Inventor: Peter Wayne Axelson, JR., Aylmer (CA)

(21) Appl. No.: 15/732,620

(22) Filed: Dec. 6, 2017

(51) Int. Cl. B60D 1/66; B60D 1/30; B60D 1/06

(52) U.S. Cl. CPC B60D 1/665; B60D 1/065; B60D 1/30

(57) ABSTRACT

Lateral stabilizer clamps, clamp kits for retrofitting such stabilizers, trailer-transporting dollies equipped with same, and methods for use thereof are variously disclosed. The stabilizer comprises a clamp operable to apply active clamping force to engage a variable-terrain-type trailer hitch coupler member in actively clamped relation against a co-operable dolly-associated clamping surface of the clamp. This engagement restrains variable-terrain lateral degrees of mechanical design freedom between the hitch coupler member and the co-operable dolly hitch member in a stabilized mutual coupling thereof.

### TECHNICAL FIELD

The invention relates to trailer transport dollies, and more particularly to their application in association with trailers employing variable terrain hitch couplings, and especially to the mechanical stabilization of the co-operably engaged dolly to trailer hitch connection. The invention is particularly suited to application in relation to the recreational and consumer trailer uses, although some embodiments (esp. lunette type trailer couplers) are also applicable to military and agricultural and construction applications.

### BACKGROUND ART

The maneuvering/parking of trailers, particularly in close-quarter parks or yards, poses problems not always facilitated by conventional tow vehicles. A variety of dollies have been proposed to aid in this connection.

U.S. Pat. No. 2,491,824 discloses a powered tractor or mule, for propelling and guiding the movement of a wheeled container. The tractor has a frame with a pair of wheels mounted on one end, and a caster at the other, and has an electric or other motor to provide motive power to the tractor. A handle member is attached to a pivot on the frame, extending upward and rearward to facilitate in operators steering of the tractor.

U.S. Pat. No. 3,156,315 pertains to dollies, and more particularly to a power-driven type thereof for maneuvering trailers and the like for parking purposes but one which addresses bulky and expensive motors, in providing a simple inexpensive, monopod dolly powered by an electric drill the handle of which doubles as an operator steering handle.

U.S. Pat. No. 3,183,013 relates to a trailer spotter to facilitate parking of travel trailers, boat trailers, and other such towed vehicles—and in particular provide a trailer spotter that provides a power advantage enabling manual crank operation instead of an electric motor.

U.S. Pat. No. 3,269,740 discloses a similar dolly utilizing a pair of supporting wheels which have a tongue with a gripping handle at the end thereof and a geared-down winch for driving the supporting wheels when operated. A two-ratio drive is provided which will permit one person to move the heaviest of the type of vehicles mentioned above from one location to another.

U.S. Pat. No. 4,588,204 discloses a caddy for pulling a trailer. A wheel is rotatably mounted to an axle which in turn is fixedly secured to an upright post into which a downwardly extending member on the trailer hitch is positionable. A handle is pivotally mounted to the axle and may be pulled to pull the trailer forwardly.

U.S. Pat. No. 5,139,102 discloses a self-propelled trailer maneuvering dolly for transporting a fifth wheel trailer or a travel trailer. The dolly has a frame, a front handlebar and castor for steering, a pair of rear drive wheels for driving the dolly, a pneumatic motor, and sprocket wheels and chains for transmitting power to the drive wheels. There is a pneumatically extensible and retractable vertical lift, which has a top for engaging with the coupling member of a fifth wheel trailer and it also has a hitch ball for hitching up to a convention travel trailer.

U.S. Pat. No. 6,663,136 discloses a coupling which interconnects a trailer and a conventional hand-held two-wheeled cart. The coupling includes a frame to which a ball of a ball and socket joint is connected. The frame has a recess which is adapted to removably receive the forward portion of a lower plate of the cart. The coupling is connected to the cart by inserting the forward portion into the recess. The coupling is then positioned such that its ball is beneath the socket on the hitch of the trailer. When the cart is tipped backward, the ball rises and enters the socket and lifts the hitch thereby permitting the trailer to be moved by the cart.

U.S. Pat. No. 6,082,755 discloses an adaptor for use a connection with a hand truck to engage a trader. The adaptor comprises a support piece and at least one slot mounted on the support piece. The at least one slot has an open end which is adapted to engage a load bearing platform of a hand truck. A tow bar is mounted on the inside of the support piece and extends upwardly at an angle from the inside of the support piece and the tow bar engages a coupler on a trailer.

U.S. Pat. Nos. 6,619,671 and 6,739,601 both disclose an improved jack for horizontally extending trailer tongue including a bracket attached to the trailer tongue, a longitudinal shaft pivotally supported to the bracket and pivotal between a substantially vertical position and a substantially horizontal position, a wheel housing supported at a lower end of the shaft, a wheel rotatably supported by the housing, a lower portion of the shaft being rotatable about a shaft longitudinal axis, a crank arm rotatably extending from said wheel housing and having a drive gear thereon, and a driven gear affixed to the wheel, the driven gear being coupled for rotation when the drive gear is rotated to cause the wheel to rotate for moving the trailer when the wheel is in contact with the earth's surface.

U.S. Pat. No. 7,845,670 discloses a trailer dolly including one or more of the following features: (a) a main body having a proximal and distal end, (b) an adjustable hitch operably coupled to the distal end of the main body, (c) at least one wheel operably coupled to the distal end of the main body, (d) an operator's handle coupled to the main body at the proximal end, (e) at least one grip coupled to the operator's handle, (f) a V-shaped support coupled to a lower side of the main body, (g) a hitch receiving aperture coupled to the distal end of the main body, (h) a support beam operably coupled to the main body at one end and the hitch receiving aperture at an opposite end, and (i) an axle coupled to the main body at the distal end and operably coupled to the at least one wheel.

### SUMMARY OF THE INVENTION

### Technical Problem

“Variable terrain” hitches are designed to accommodate various degrees of freedom of relative lateral (i.e. latitudinal and/or longitudinal shifts in horizontal orientation, or “roll” and/or “pitch” between the tow vehicle's and trailer's respective attitudes) movement across the hitch junction between respective cooperating hitch members of a trailer coupler and a tow vehicle. This permits the respective orientations of the towed trailer and the tow vehicle to respond with more independent lateral (meaning latitudinal and/or longitudinal) freedom of movement, as necessary to accommodate differences in the level of the terrain on which they are each supported during transit. The nature of this type of hitch freely accommodates a range of transitions between mutually coplanar (i.e. “level towing”) and non-coplanar orientation's of the trailer and the tow vehicle, during normal towing operations. This distinguishes the utility, structure and function of variable terrain hitches from fixed coplanar hitches which are not designed to accommodate such variations.

There is an underlying problem that arises in trailer parking/positioning when circumstances are such that a conventional tow vehicle is unsuited to the required maneuvering, or is not available for use. Trailer dollies (also variously referred to as “mules” or the like), can be used to facilitate this need, especially when conventional tow vehicles will not serve or not serve as well. These dollies are typically single wheel or other narrow tracking, short wheel base, two to four wheeled (or tracked) devices adapted to be hitched with the trailer to be moved. In the case of trailers which are equipped with a variable terrain hitch, however, the dolly's connection to the trailer can introduce corresponding instability in the trailer/dolly towing arrangement, and result in a risk of tipping, or problems with controlled maneuvering. The design virtues of this hitch type for normal towing operations become problematic and even a potential liability during dolly-facilitated repositioning of the trailer. The lateral degrees of freedom afforded by the variable terrain hitch can complicate the controlled operation of the dolly, even raising safety concerns for persons as well as the risk of property damage. Accordingly, there is a need for the dolly-trailer hitching relationship to be stabilized—and more particularly, to provide more or less universally for such stabilization regardless of any particular style, dimensioning, or form of fabrication of a particular manufacturer's variable terrain trailer hitch member's particular characteristics. The stabilization must be reliable and physically robust and should not be dependent on trailer tongue features that may be absent in any particular design or, weaker than the trailer coupler was otherwise designed to service.

### Solution to the Problem

An embodiment of the present invention provides for a lateral stabilizer clamp for use with a trailer-transporting dolly, comprising a clamp operable to apply (pref. “active”) clamping force to engage a variable-terrain-type trailer hitch coupler member in actively clamped relation against a co-operable dolly-associated clamping surface of the clamp. This clamping operation thereby restrains variable-terrain lateral degrees of mechanical design freedom between the hitch coupler member and a co-operable dolly hitch member in a mutual coupling thereof.

In an embodiment, the active clamping force associated with the lateral stabilizer clamp, to be applied on at least some of opposing sides of the coupling, and preferably the application of the clamping force biases the coupling towards a laterally-neutral orientation with respect to the coupler.

More particularly, it is advantageous for the (pref. active) clamping force to be applied in substantial coupling-surrounding relation. This force then loads the coupling in surrounding relation to the coupling—i.e. with the coupling located more or less centrally and the application of the loading force on surrounding surfaces to distribute the lateral stabilization effect. This stabilizes the trailer dolly relationship against relative forward/backward and side to side movements.

Also in accordance with an aspect of the present invention, there is provided a trailer-positioning-dolly, variable terrain, hitch stabilizer comprising an elevator platform selectively vertically repositionable between trailer tongue engaging and disengaging positions, and operable with said elevator platform positioned in said tongue engaging position by an associated dolly elevator platform positioning device, to force an at least one stabilizer surface of said platform into preloaded contacting engagement against a corresponding portion of the trailer tongue of a trailer secured in towable relation with said dolly through respective cooperating variable terrain hitch members thereof, to reduce the lateral degrees of freedom otherwise available through the secured towable relation of said respective hitch members for relative lateral motion between the mutually hitched dolly and trailer.

### Advantageous Effects

Defeating or at least limiting variable terrain degrees of freedom using a clamp, to facilitate the use of a trailer hitched to a dolly offers improved stability, safety and reduced risk of property damage. The use of active clamping forces to this end aids in resisting the freedom of movement. In some embodiments, the application of clamping force using the cooperating trailer hitch coupler and dolly hitch member structure in coupled relation takes advantage of their purpose-built structural strength to bias the clamping relationship to these ends.

### BRIEF DESCRIPTION OF THE DRAWINGS

FIG. 1 is an elevated perspective view of a variable terrain hitch stabilizer according to the present invention;

FIG. 2 is an elevated side view, showing a hitch stabilizer according to the present invention with a clamping surface and its supporting sleeve in exploded relation above a spindle supporting column;

FIG. 3 is a sectional view through a coupling, with a hitch stabilizer clamping surface oriented just beneath the coupler;

FIG. 4 is an elevated front view of the nose of the coupler, with the hitch stabilizer engaged with the coupler's underside; and,

FIG. 5 is an elevated side view of the arrangement depicted in FIG. 4.

FIG. 6 depicts a lunette adapter and trailer hitch coupler lunette according to aspects of the present invention.

FIGS. 6a and 6b are also views of the lunette adapter shown in FIG. 6.

FIG. 7 illustrates a view of the trailer hitch coupler in phantom, overlaying the restriction plate (a horse-shoe shaped version thereof) in surrounding relation below the axis of the spindle.

FIGS. 8 through 11 depict an embodiment of the invention employing a toggle actuator.

### DESCRIPTION OF EMBODIMENTS

In general, except where otherwise self-evident, embodiments of the invention can provide for a variable terrain hitch stabilizer for use in association with a trailer-transporting dolly in transporting a trailer equipped with a tongue including a terminal variable terrain hitch coupler when arranged in a coupling with a dolly-associated hitch spindle. The spindle is adapted to be interferingly-coupled with trailer coupler in mutually-secured trailer towable relation therewith. The stabilizer comprises a clamping surface, which is positionable to engage against the coupler (when the coupler is coupled with the interferingly-coupled spindle), in substantially-spindle-surrounding relation and acting across the coupling to mechanically restrict variable-terrain degrees of lateral mechanical freedom otherwise associated with coupler.

The advantage of this is that the substantially surrounding relationship provides balanced leverage around the coupling for restricting the previously mentioned lateral degrees of freedom. Moreover, the surrounding engagement between the clamping surface and the coupler is preferably immediately proximal to the coupling, shortening the leveraging distance between the coupling and the clamping surface engagement with the coupler.

The hitch stabilizer preferable includes a stabilizer clamping surface which is biased into forced engagement against the coupler, and acting in opposition to the coupling's interferingly-coupled relation, (i.e. drawing the coupled spindle against the interfering stricture of the coupling). This takes advantage of the coupler's structural design accommodation for the stresses associated with regular vehicular towing operations and the accommodation thereof for associated variable terrain movement in the design and materials of the purpose-built coupling engagement. In accordance with this aspect of the present invention it is those very features that are employed to act in opposition to such variable terrain accommodating movement.

The hitch stabilizer is preferably adapted for use with a dolly-borne spindle selected from one of the group consisting of a ball-shaped spindle adapted for engagement in a socket hitch pairing; or a tapered spindle adapted for engagement in a lunette hitch pairing. In the case of a ball shaped spindle, it is the ball shaped terminal end of the spindle that is engaged in the socket, much as such a ball is conventionally used in together with an underjaw of the coupler and an opposite a portion of the socket wall, to mutually (interactively) interfere with a tapering side wall of the ball to prevent its uncoupling from the socket. In the lunette case, it is the tapered sidewall of a cone for example that is interferingly captured within the interfering stricture of the encircling lunette ring that serves the interfering coupling. In this respect, the present invention is advantageously applicable to two of the most common North American forms of trailer hitches—the ball and socket so very common in utility and recreational applications, and the lunette type more typically reserved for construction, agricultural and military applications.

In an aspect of the invention, the hitch stabilizer provides for the clamping surface to be selectively positionable between coupler-engaged and coupler-disengaged positions respectively when the coupler is so coupled with the interferingly-coupled spindle. In any case, this aspect of the invention advantageously relieves the clamping effect before disengaging the coupling and asserts the clamping effect after the coupling has been established. It is particularly advantageous when the clamping surface is adapted to engage the coupler with a forced clamping bias.

In an aspect of the present invention, spindle is axially oriented in the coupling, with the clamping surface being selectively positionable in co-axial relation there around, between the coupler-engaged and coupler-disengaged positions. This arrangement offers structural and operational simplicity for achieving the surrounding engagement mentioned hereinbefore.

In the illustrated embodiments, the trailer tongue extends generally orthogonally to the spindle's axial orientation. This aspect of the stabilizer arrangement is also advantageous for use in common types of North American variable terrain hitches.

The hitch stabilizer is preferably arranged on a spindle-supporting dolly fixture and in bridging relation between same and the coupler, to act there between in restricting the variable-terrain degrees of lateral mechanical freedom. Fixture is a spindle supporting column associated with the dolly, which supports the spindle in elevated relation above a dolly undercarriage.

In some aspects of the invention, the column-supported spindle elevation above the undercarriage is selectively adjustable. This arrangement also has the advantage that mounting the jack base on the column rather than somewhere else of the dolly undercarriage permits the jack and the stabilizer with the clamping surface to be raised or lowered with the spindle column as a whole in embodiments where the dolly provides for that. In the illustrated embodiment, the clamping surface is selectively positionable relative to the spindle supported on the column. This is, for example, where the jack's base is mounted on a column-secured sleeve, and the working of the jack extends and retracts the business end to move the clamp in and out of coupler engaging relation.

The clamping surface is preferably a platform adapted to be supported by the dolly and the spindle is adapted to engage an upper side portion of the coupler and the platform is adapted to engage the coupler's opposing underside portion in clamped relation there against.

Embodiments according to the present invention, include a stabilizer hitch kit adapted for mounting on a dolly, and supported thereby to present the clamping surface to be so positionable for engagement with the coupler. The present invention also includes the hitch stabilizer in combinations including a dolly and supported thereby to present the clamping surface to be positionable to engage the coupler when so coupled with the interferingly-coupled spindle, in substantially-spindle-surrounding relation and acting across the coupling, (to, as previously mentioned, mechanically restrict variable-terrain degrees of lateral mechanical freedom otherwise associated with the coupler).

In one aspect of the present invention a lateral stabilizer clamp for use with a trailer-transporting dolly, comprises a clamp operable to apply active clamping force to engage a variable-terrain-type trailer hitch coupler in actively clamped relation against a co-operable dolly-associated clamping surface of the clamp, to thereby restrain variable-terrain lateral degrees of mechanical design freedom between the hitch coupler and a co-operable dolly hitch spindle in a mutual coupling thereof. To that end, a hydraulic or pneumatic jack providing force-multiplier clamping force is preferred. Preferably, the active clamping force is applied on at least some of opposing sides of the coupling and most preferably in substantially surrounding relation thereto. The action of the clamping force preferably biases the coupling towards a laterally-neutral orientation with respect to the coupler, and restrains against variable terrain freedom of movement.

Referring now in particular to the embodiments depicted in the drawings, there is provided a variable-terrain-movement restricting clamp 1 for use in a dolly for towing a trailer equipped with a hitch having variable terrain trailer coupler 3. The variable-terrain-movement restricting clamp 1 comprises a dolly coupler 5 and a dolly-coupler-opposing, variable-terrain-movement restriction plate 6, which are respectively positionable between paired mutual clamping and unclamping positions with the trailer coupler 3 correspondingly clamped or unclamped therebetween. The dolly coupler 5 is adapted to mutually couple (as shown by coupling 4) with the variable terrain trailer coupler 3 to provide anchored opposition for the restriction plate 6 to secure the trailer coupler 3 in clamped variable terrain movement restricting relation between the dolly coupler 5 and the restriction plate 6 when in the clamping position.

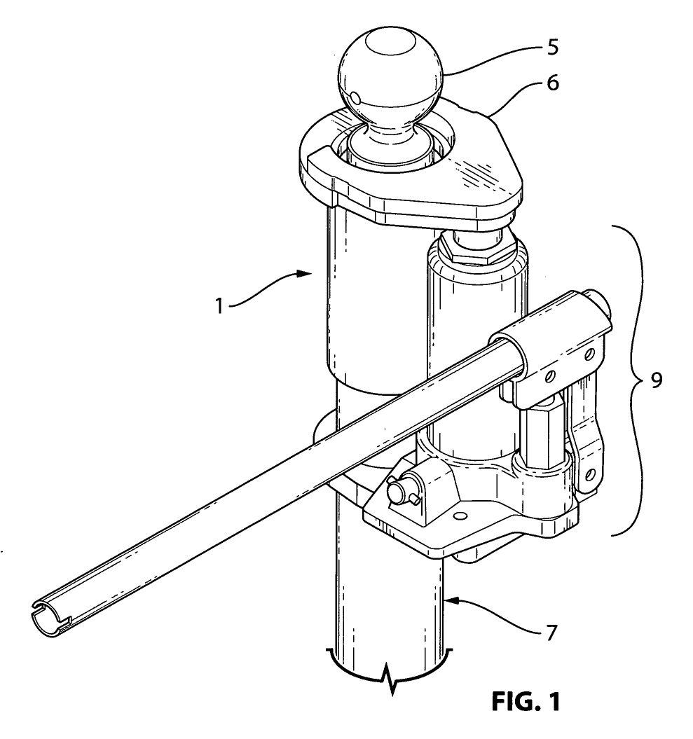

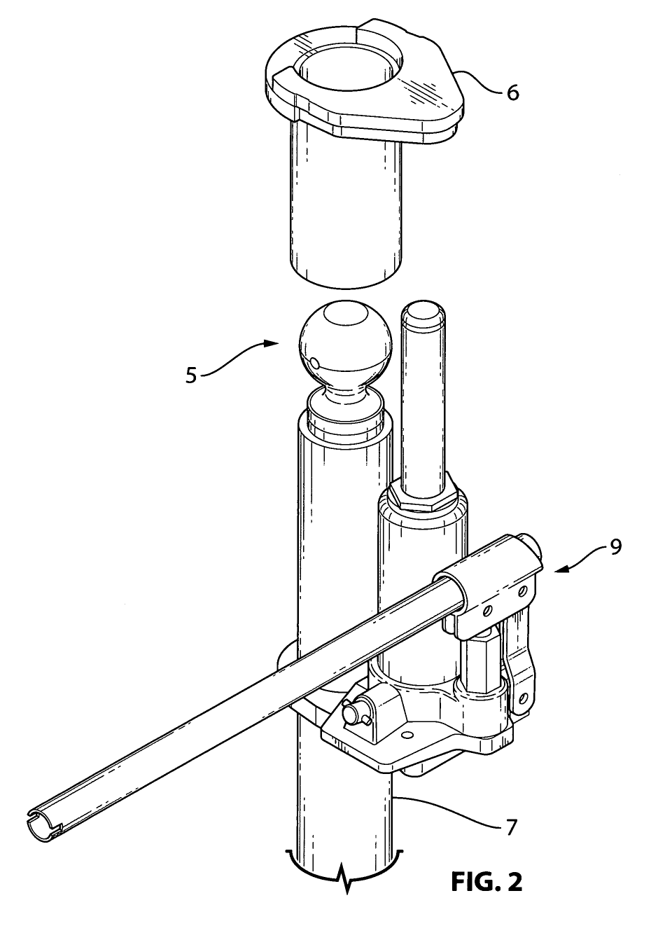

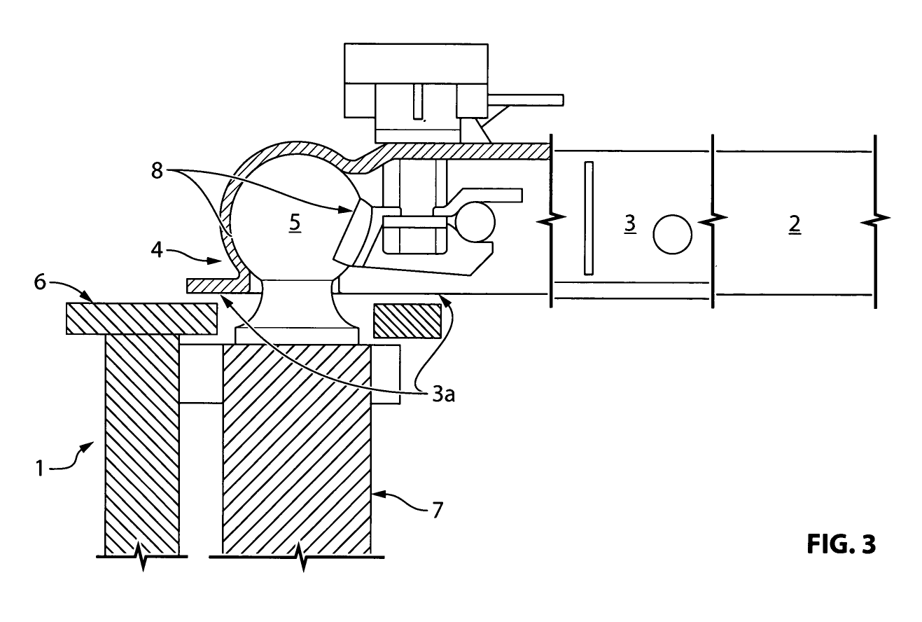

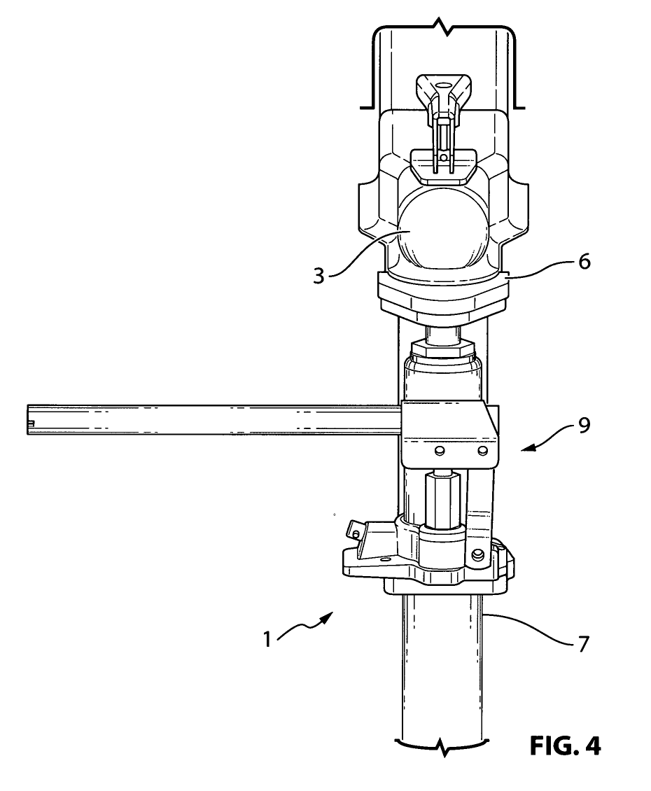

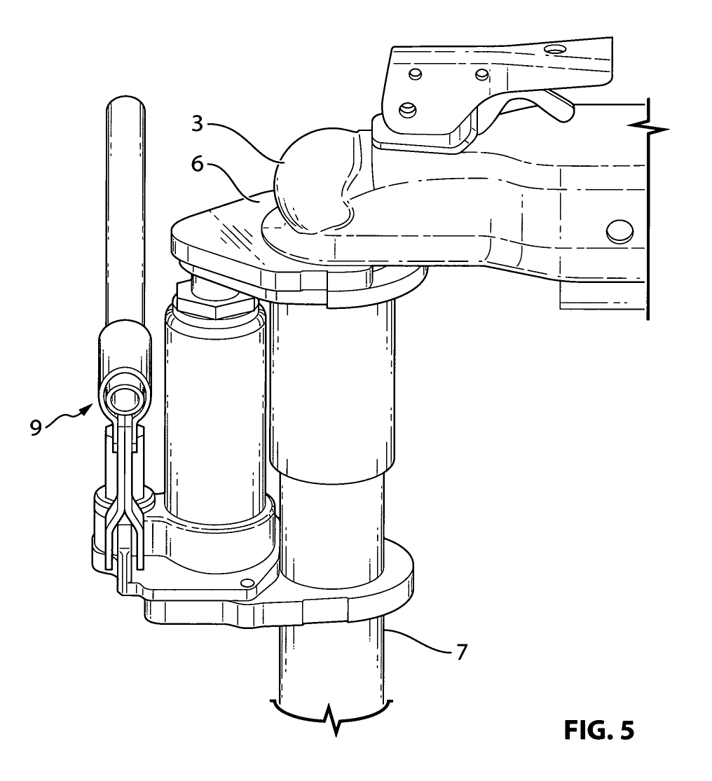

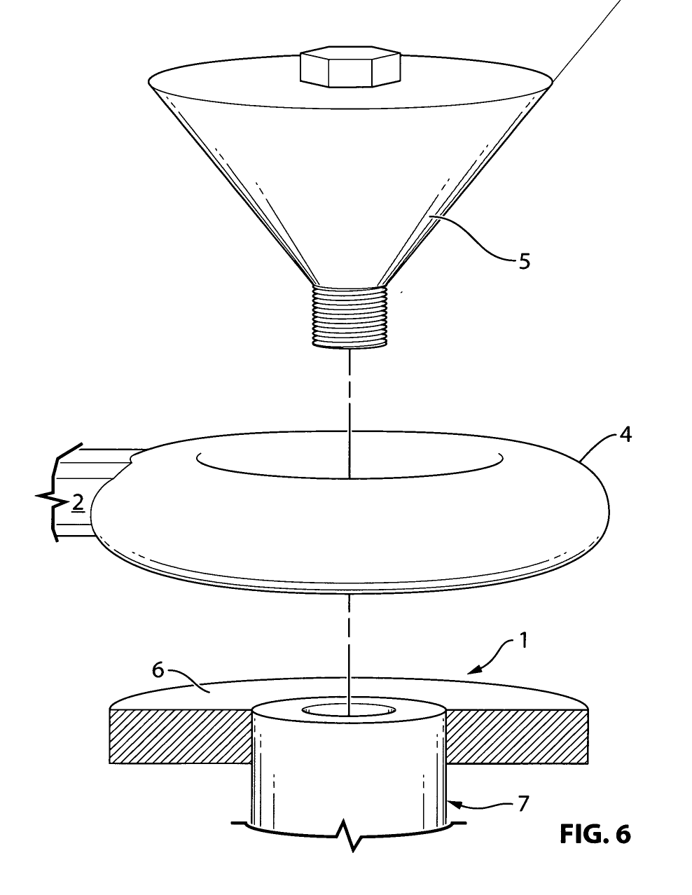

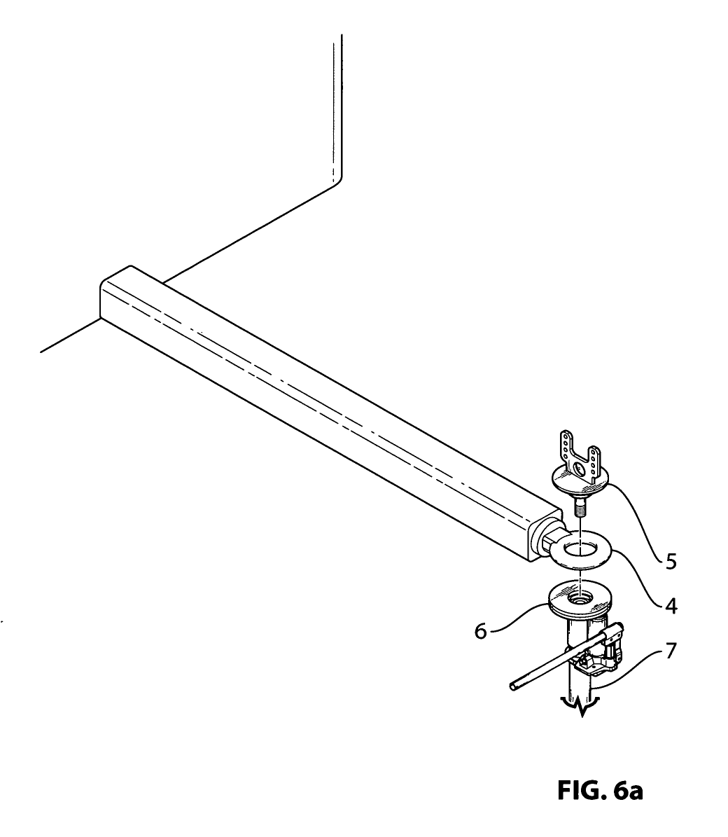

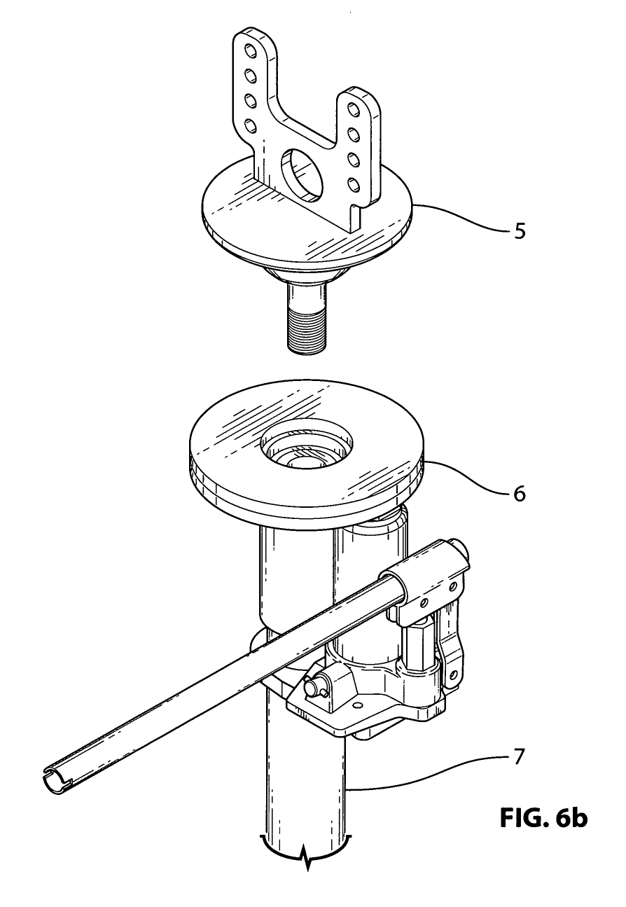

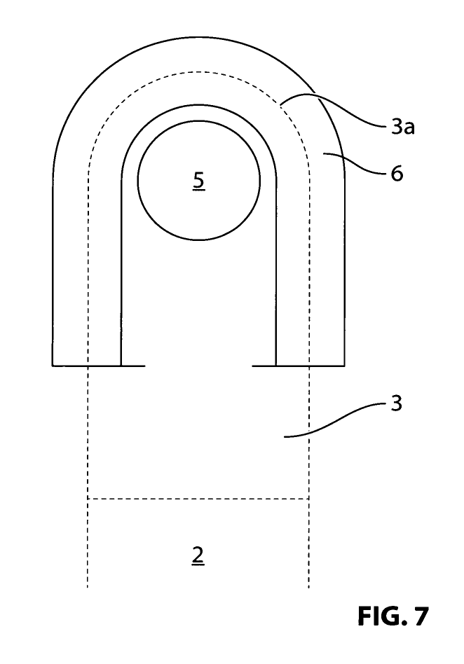

The dolly coupler 5 is preferably selected for mutual compatibility with a corresponding variable terrain trailer coupler 3 comprised of one of the group consisting of a ball securing underjaw/socket combination (as shown in FIGS. 1-5); or a lunette 6, 6a and 6b.

The restriction plate 6 is adapted to contact the trailer coupling in roll and pitch interfering relation, when trailer coupling 3 is engaged in clamped relation between the dolly coupler 5 and the restriction plate 6. In this sense, roll refers to rotational movement around the trailer tongues longitudinal axis and pitch refers to the vertical movement arising when the tow vehicle and the trailer are in differing longitudinal planes, while yaw refers to the steering pivot around the coupling between the tow vehicle and the trailer. Note that while a circular restriction plate 6 could be employed, there are advantages arising out of the use of a horse-shoe shaped plate 6 relating to variations in different manufacturers designs of trailer hitch 3.

The clamp 1 includes an actuator 9 for relatively positioning the dolly coupler 5 and the restriction plate 6 between clamping and unclamping positions. Actuator 9 preferably comprises a jack for raising or lowering the restriction plate relative to the dolly coupler 5, between the clamping and unclamping positions. Mechanical, pneumatic, hydraulic or electric jacks or the like can find application in this connection. The jack as illustrated is able to provide hundreds and even thousands of pounds of clamping force.

In an aspect of the present invention there is provided a variable-terrain-movement restricting clamp kit comprising a dolly-coupler-opposing, variable-terrain-movement restriction plate 6 and an actuator 9, for use in a dolly having a dolly coupler for towing a trailer equipped with a hitch having variable terrain trailer coupler 3 to provide a variable-terrain-movement restricting clamp 1. The dolly coupler 5 and the dolly-coupler-opposing, variable-terrain-movement restriction plate 6 are adapted to be respectively positionable between paired mutual clamping and unclamping positions by the actuator 9 with the trailer coupler 3 correspondingly clamped or unclamped therebetween and with the dolly coupler 5 being adapted to mutually couple 4 with the variable terrain trailer coupler 3 to provide anchored opposition for the restriction plate 6 to secure the trailer coupler 3 in clamped variable terrain movement restricting relation between the dolly coupler 5 and the restriction plate 6 when in the clamping position.

Another aspect of the present invention includes a lunette-compatible dolly coupler 6 comprising an inverted cone or dome for engaging tapering sidewall portions thereof in self-centering, mutually concentric contacting relation with inside ring wall portions of a compatible lunette. In one aspect of the present invention this lunette-compatible dolly coupler 6 includes mounting hardware for co-joining the dolly coupling 5 to a supporting dolly fixture 7. In a preferred form, the mounting hardware comprises a threaded extension adapted to be treadably engaged with a correspondingly threaded supporting dolly fixture 7. Note too that in embodiments where the plate 6 is fixed to the spindle 7, the threaded engagement of coupling 5 may be used to engage the tapering side walls of the coupling 5 against the inner ring wall of the lunette 4 to engage the lunette in clamped relation between coupling 5 and plate 6. Note too that the coupling 5 may include a hexagonal or other nut feature to facilitate the coupling 5 engagement, or alternative features compatible variously with bars or other tools to engage the coupling with fixture 7.

In accordance with the operation of the certain embodiments of the present invention there is provided a method of engaging a variable-terrain-type hitch coupling between a trailer-transporting dolly and trailer, in laterally stabilized coupled hitch relation comprising the steps of orienting the dolly relative to the trailer so the coupler is engageably aligned with a dolly hitch member (spindle); coupling the hitch coupling; and, engaging a lateral stabilizer clamp to apply active clamping force to engage a trailer hitch coupler in actively clamped relation against a co-operable dolly-associated clamping surface of the clamp, to thereby restrain variable-terrain lateral degrees of mechanical design freedom between the hitch coupler member and a co-operable dolly hitch spindle in the mutual coupling thereof.

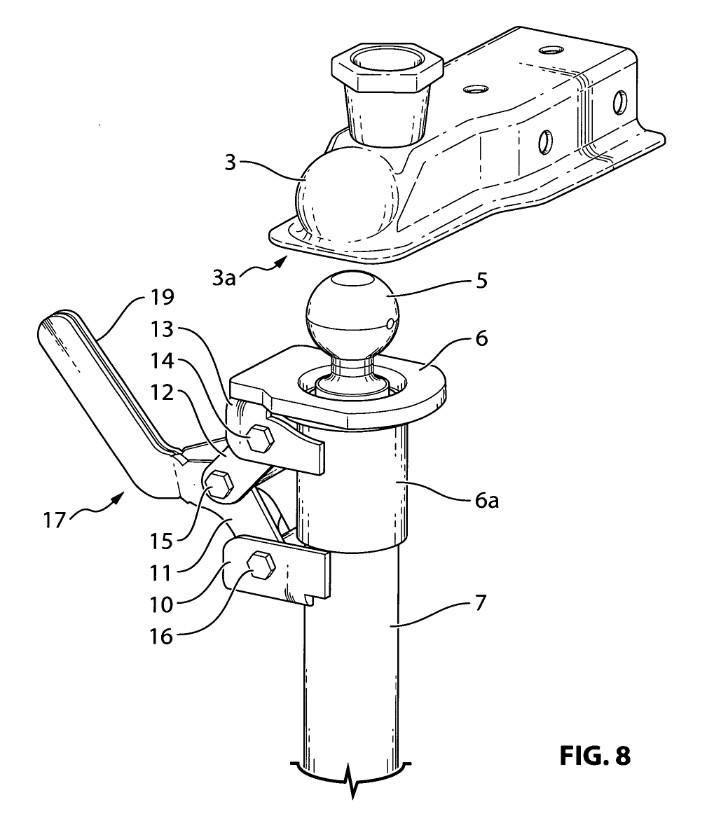

Referring now in general to FIGS. 8 through 11, and in accordance with the practice of the present invention: there are special and substantive advantages associated with the simplicity of mechanical actuators. Such actuators may include, for example, screw actuated clamps (not shown) in which a nut is adapted to ride on a threaded portion of spindle-supporting dolly fixture and acting (whether directly on the restriction plate or indirectly on it through a sleeve adapted to ride the spindle) to position the clamping surface of the restriction plate against the underside portion of the trailer hitch coupler. While significantly less expensive than the pneumatic or hydraulic jack embodiments described hereinbefore, the nut is likewise slow acting, and requires a wrench to supply leverage, which can be lost or misplaced. Lock nuts or lock washers may be required to secure the nut actuated clamp into secured hitch stabilizing relation.

Accordingly, preferred mechanical actuators include faster-acting, “past center” clamp actuators, including cams (not shown) or toggles (as illustrated in the embodiment variously depicted in FIGS. 8 through 11.

Cams actuators include eccentric and spiral types, which may employ friction locking, but may alternatively employ “past center” flats which are generally more secure than simple friction engagements. Cam actuators however, require machined cam surfaces that add to their expense, and more importantly, may not be readily available to affect repairs in the field use.

Accordingly, in the practice of the present invention, toggle actuators are especially preferred: being cheap, light, easy to repair with readily produced parts—fast acting—and providing superior past-center locking of the clamp into trailer hitch stabilizing relation.

The arrangement of the various levers and connections via pivot pins, supply the engagement/disengagement action and clamping force. Toggle action has an over-center lock point which is a fixed stop and linkage. Once in the over-center position, the clamp cannot move or unlock unless the linkage is moved. All types of toggle clamps have this same action, just oriented differently.

In general, toggle clamps are quick-action clamp actuators as shown in FIGS. 8 through 11, operate through a system of levers 10, 11, 12 and 13 and pivots 14, 15 and 16. The toggle actuator 17 locks positively by moving the clamp's center pivot 15 past the centerline of the other pivots 14 and 16, and against a stop 18 (in this case against the side wall of the spindly-riding sleeve on which the restriction plate 6 is mounted. Lever (or bracket) 13 is fixed in this case to both an underside of clamping surface 6 and sleeve 6a, while lever (or bracket) 10 is fixed to spindle-supporting dolly fixture 7. Sleeve 6a is adapted to slide along fixture 7 under the operation of handle 19. With the toggle actuator locked in this orientation the restriction plate clamping surface 6 remains in clamping engagement with the underside portion 3a of the trailer hitch coupler 3, until a user moves the handle 19 to release the toggle. By way of comparison, cam actuators use frictional force (which may or may not be augmented by flats on the cam surface) to affect a locking condition. Toggle actuators have many advantages over cam actuated clamps, but of primary importance is the fact that cam actuated clamps allow some movement while clamping. Toggle actuated clamps thus provide a more consistent clamping point, can be manufactured from inexpensive materials, and are available in stainless steel for outdoor or corrosive applications.

In order to accommodate variations, such as different ball sizes of dolly hitch coupling spindle 5 for example, the positioning of the actuator on the spindle-supporting dolly fixture, the length of the various levers and relative positioning of the pivots can be varied (including for example, by providing a series of alternative holes or slots (not shown) to accommodate different positioning for pivot 16 in lever 10. A simple expedient however, involves threading dolly coupling spindle 5 into the spindle-supporting dolly fixture 7, to accommodate the actuator's fixed lever/pivot arrangement) locking position.

In operation of the embodiment illustrated in FIGS. 8 through 11, the variable terrain-movement restricting clamp of the present invention is actuated through a user's operation of handle 19 between clamped and unclamped positions. With handle 19 in the unclamped position the spindle 5 (in this case a ball) and the trailer hitch coupler 3 are aligned facilitate their interconnected registration. This pre-registration alignment is shown in FIG. 8.

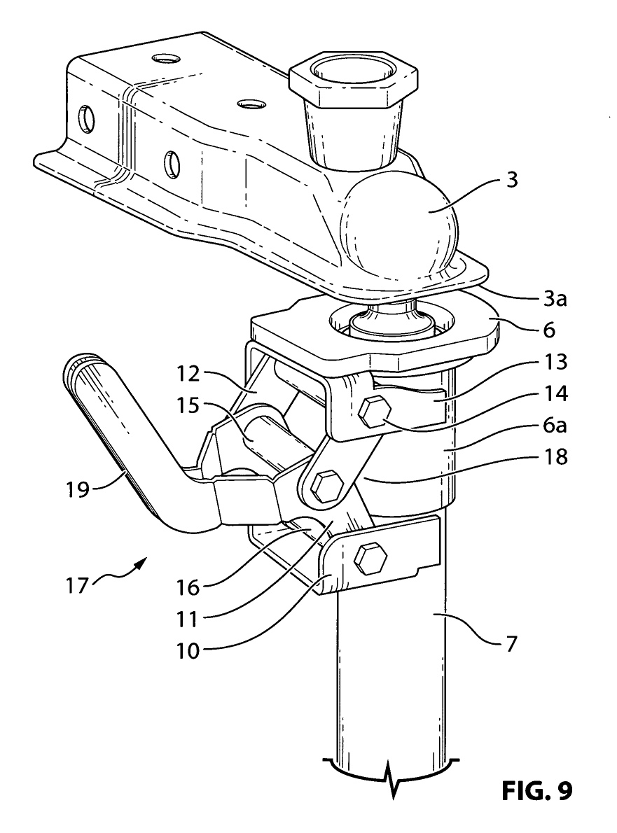

As depicted in FIG. 9, with handle 19 still in the unclamped position, trailer hitch coupler 3 can be interconnected with the spindle 5 and as previously described, the underjaw of coupler 3 can be engaged to capture the spindle 5 ball in secured relation within coupler 3. Note that the underside 3a of coupler 3, and the clamping surface 6 of the movement restricting clamp are located in mutually spaced apart relation from one another.

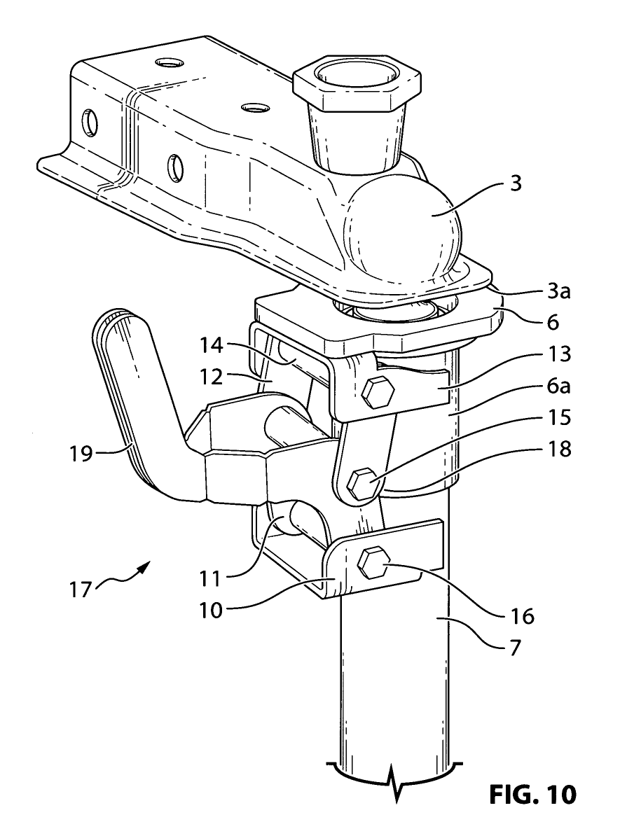

FIG. 10 illustrates an intermediate stage of the operation of the toggle actuator 17, with handle 19 moved from the unclamped position of FIGS. 8 and 9, and progressing towards engagement of clamping surface 6 against underside 3a. The movement of the handle 19 acts through levers 10, 11, 12 and 13 and pivots 14, 15 and 16 to slide sleeve 6a along fixture 7, and in turn moving clamping surface 6 into closer proximity to and eventually into contact with underside 3a.

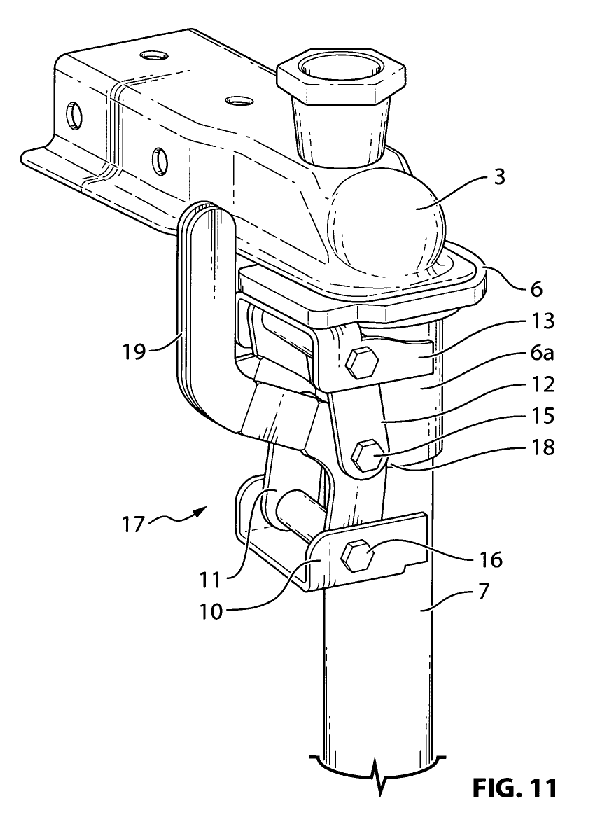

Once handle 19 is moved into clamping position shown in FIG. 11, the pivot 15 has been moved “past center” alignment of pivots 14 and 16 (and engaged with stop 18 on sleeve 6a), and hence locking toggle actuator 17 into position with clamping surface 6 engaged in movement restricting relation against underside 3a. To release toggle actuator from this locked engagement, handle 19 must be pulled to overcome the past center locking force.

The advantages of toggle clamps in their application to the present invention include fast action in clamping and release of the hitch stabilizing engagement; ease of incorporation into their combination with other features of the invention; versatility of toggle types (push, pull, hold-down etc.) to allow for alternative construction configurations if desired; durability, low maintenance and resistance to environmental issues; and costs savings associated with tool design and manufacture, parts production and availability for repairs. All of these features are important to the application of toggle actuators in the present invention.

### INDUSTRIAL APPLICABILITY

The present invention is applicable to the manufacturing and use of trailer dollies that can be equipped with the variable terrain hitch stabilizer according to the present invention.

### REFERENCE SIGNS LIST

variable terrain hitch stabilizer comprising a variable terrain-movement restricting clamp 1.
tongue 2 including a variable terrain trailer coupler 3.
variable terrain trailer hitch coupler 3.
trailer hitch underside portion 3a for engaging with plate 6.
mutual coupling 4 between the variable terrain trailer coupler 3 and the dolly coupler 5.
dolly-associated hitch spindle (i.e. the dolly coupler) 5.
clamping surface 6 (i.e. variable-terrain-movement restriction plate 6).
Sleeve 6a attached to clamping surface 6.
spindle-supporting dolly fixture 7.
an upper side portion 8 (of trailer hitch coupler 3).
opposing underside portion 3a of trailer hitch coupler 3).
Actuator 9 (e.g. a jack).
Levers 10, 11, 12, 13 of toggle actuator 17
Pivots 14, 15 and 16 of toggle actuator 17.
Stop 18
Handle 19.

### REFERENCE TO DEPOSITED BIOLOGICAL MATERIAL

Not applicable in this case.

### SEQUENCE LISTING FREE TEXT

Not applicable in this case.

### CITATION LIST

### Patent Literature

U.S. Pat. No. 2,491,824
U.S. Pat. No. 3,156,315
U.S. Pat. No. 3,183,013
U.S. Pat. No. 3,269,740
U.S. Pat. No. 4,588,204
U.S. Pat. No. 5,139,102
U.S. Pat. No. 6,663,136
U.S. Pat. No. 6,082,755
U.S. Pat. No. 6,619,671
U.S. Pat. No. 6,739,601
U.S. Pat. No. 7,845,670

### Non Patent Literature

Not applicable in this case

1. A variable-terrain-movement restricting clamp for use in a dolly for towing a trailer equipped with a hitch having variable terrain trailer coupler, said variable-terrain-movement restricting clamp comprising:
a dolly coupler and a dolly-coupler-opposing, variable-terrain-movement restriction plate, respectively positionable between paired mutual clamping and unclamping positions with said trailer coupler correspondingly clamped or unclamped therebetween; and,
with said dolly coupler being adapted to mutually couple with said variable terrain trailer coupler to provide anchored opposition for said restriction plate to secure said trailer coupler in clamped variable terrain movement restricting relation between said dolly coupler and said restriction plate when in said clamping position.

2. The clamp according to claim 1, wherein said dolly coupler is selected for mutual compatibility with a corresponding variable terrain trailer coupler comprised of one of the group consisting of a ball securing underjaw/socket combination; or a lunette.

3. The clamp according to claim 1 wherein said restriction plate is adapted to contact said trailer coupling in roll and pitch interfering relation, when said trailer coupling is engaged in clamped relation between said dolly coupler and said restriction plate.

4. A dolly for towing a trailer equipped with a hitch having a variable terrain trailer coupling, comprising a clamp according to claim 1.

5. The dolly according to claim 4 wherein said clamp includes an actuator for relatively positioning said dolly coupler and restriction plate between clamping and unclamping positions.

6. The dolly according to claim 5, wherein said actuator comprises a jack for raising or lowering said restriction plate relative to said dolly coupler, between said clamping and unclamping positions.

7. A variable-terrain-movement restricting clamp kit comprising a dolly-coupler-opposing, variable-terrain-movement restriction plate and an actuator, for use in a dolly having a dolly coupler for towing a trailer equipped with a hitch having variable terrain trailer coupler to provide a variable-terrain-movement restricting clamp, and wherein said dolly coupler and said dolly-coupler-opposing, variable-terrain-movement restriction plate are adapted to be respectively positionable between paired mutual clamping and unclamping positions by said actuator with said trailer coupler correspondingly clamped or unclamped therebetween; and, with said dolly coupler being adapted to mutually couple with said variable terrain trailer coupler to provide anchored opposition for said restriction plate to secure said trailer coupler in clamped variable terrain movement restricting relation between said dolly coupler and said restriction plate when in said clamping position.

8. A lunette-compatible dolly coupler comprising an inverted cone or dome for engaging tapering sidewall portions thereof in self-centering, mutually concentric contacting relation with inside ring wall portions of a compatible lunette.

9. The lunette-compatible dolly coupler according to claim 8 including mounting hardware for co-joining said dolly coupling to a supporting dolly fixture.

10. The lunette-compatible dolly coupler according to claim 9 wherein said mounter hardware comprises a threaded extension adapted to be treadably engaged with a correspondingly threaded supporting dolly fixture.
